(19) United States
(12) Patent Application Publication
(10) Pub. No.: US 2022/0167292 A1
(43) Pub. Date: May 26, 2022

(54) WIRELESS COMMUNICATION DEVICE, SYSTEM, AND STORAGE MEDIUM

(71) Applicant: KABUSHIKI KAISHA TOKAI RIKA DENKI SEISAKUSHO, Aichi (JP)

(72) Inventors: Yosuke OHASHI, Aichi (JP); Masateru FURUTA, Aichi (JP); Yuki KONO, Aichi (JP); Yutaka KUBO, Aichi (JP)

(73) Assignee: KABUSHIKI KAISHA TOKAI RIKA DENKI SEISAKUSHO, Aichi (JP)

(21) Appl. No.: 17/517,117

(22) Filed: Nov. 2, 2021

(30) Foreign Application Priority Data
Nov. 26, 2020 (JP) 2020-195798

(51) Int. Cl. H04W 56/00; H04W 4/48

(52) U.S. Cl. CPC H04W 56/004; H04W 4/48

(57) ABSTRACT

There are provided a new and improved wireless communication device, storage medium, and system that can more precisely measure a distance between devices.

A wireless communication device includes: a wireless communication section configured to transmit and receive a signal that conforms to predetermined communication standards; and a processing section configured to execute a correction process of correcting an operation error during an operation, the operation error being caused by a clock shift between the wireless communication device and another wireless communication device, and the operation being based on a time at which the signal has been transmitted and received between the wireless communication device and the another wireless communication device.

### CROSS REFERENCE TO RELATED APPLICATION(S)

This application is based upon and claims benefit of priority from Japanese Patent Application No. 2020-195798, filed on Nov. 26, 2020, the entire contents of which are incorporated herein by reference.

### BACKGROUND

The present invention relates to a wireless communication device, a system, and a storage medium.

In recent years, a technology that performs various processes according to a result of transmission and reception of wireless signals between devices has been developed. In, for example, following JP2020-118030, a distance between devices is measured by using an Ultra Wide Band (UWB) signal.

### SUMMARY

In the above system, a clock shift between devices that transmit and receive wireless signals to and from each other is likely to cause an influence on a distance measurement operation.

Hence, the present invention has been made in light of the above problem, and an object of the present invention is to provide a new and improved wireless communication device, storage medium, and system that can more precisely measure a distance between devices.

To solve the above problem, a certain aspect of the present invention provides a wireless communication device that includes: a wireless communication section configured to transmit and receive a signal that conforms to predetermined communication standards; and a processing section configured to execute a correction process of correcting an operation error during an operation, the operation error being caused by a clock shift between the wireless communication device and another wireless communication device, and the operation being based on a time at which the signal has been transmitted and received between the wireless communication device and the another wireless communication device.

Furthermore, to solve the above problem, another aspect of the present invention provides a non-transitory computer readable storage medium that has a program stored therein and causing a computer to realize: a wireless communication control function configured to transmit and receive a signal that conforms to predetermined communication standards; and a processing function configured to execute a correction process of correcting an operation error during an operation, the operation error being caused by a clock shift between wireless communication devices, and the operation being based on a time at which the signal has been transmitted and received between the wireless communication devices that have transmitted and received the signal.

Furthermore, to solve the above problem, still another aspect of the present invention provides a system that includes: a first wireless communication device; and a second wireless communication device, and in which the first wireless communication device includes a wireless communication section configured to transmit and receive a signal that conforms to predetermined communication standards, and a processing section configured to execute a correction process of correcting an operation error during an operation, the operation error being caused by a clock shift between the first wireless communication device and the second wireless communication device, and the operation being based on a time at which the signal has been transmitted and received between the first wireless communication device and the second wireless communication device.

As described above, according to the present invention, it is possible to more precisely measure a distance between devices.

### BRIEF DESCRIPTION OF THE DRAWINGS

FIG. 1 is a block diagram illustrating a configuration example of a system 1 according to the present embodiment.

FIG. 2 is a sequence diagram for explaining an example of a correction process of correcting an operation error caused by a clock shift between in-vehicle equipment 10 and a portable device 20 according to the present embodiment.

### DETAILED DESCRIPTION OF THE EMBODIMENT(S)

Hereinafter, referring to the appended drawings, a preferred embodiment of the present invention will be described in detail. It should be noted that, in this specification and the appended drawings, structural elements that have substantially the same function and structure are denoted with the same reference numerals, and repeated explanation thereof is omitted.

### 1. Embodiment

<<1.1. System Configuration Example>>

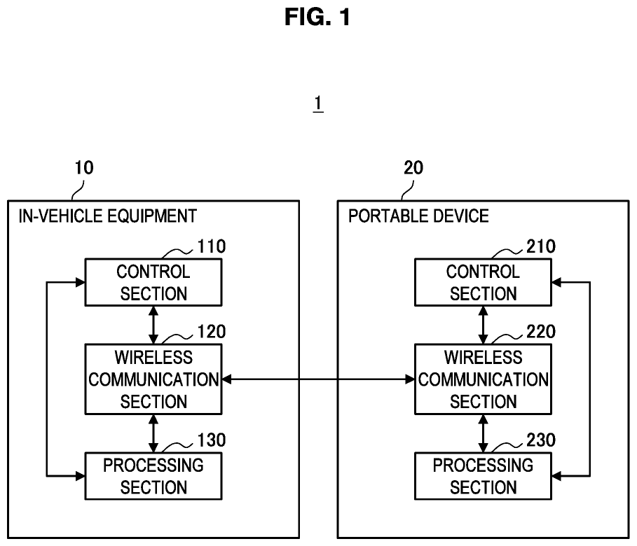

First, the configuration example of a system 1 according to the embodiment of the present invention will be described. FIG. 1 is a block diagram illustrating the configuration example of the system 1 according to the present embodiment.

As illustrated in FIG. 1, the system 1 according to the present embodiment includes in-vehicle equipment 10 and a portable device 20.

(In-Vehicle Equipment 10)

The in-vehicle equipment 10 according to the present embodiment is an example of a wireless communication device according to the present embodiment. The in-vehicle equipment 10 according to the present embodiment may be, for example, a communication unit that is mounted on a vehicle that a user is permitted to get on (e.g., a vehicle possessed by the user or a vehicle that is temporarily lent to the user).

As illustrated in FIG. 1, the in-vehicle equipment 10 according to the present embodiment includes a control section 110, a wireless communication section 120, and a processing section 130.

The control section 110 is an example of a control section according to the present invention, and controls an entire operation of the in-vehicle equipment 10. For example, the control section 110 controls transmission and reception of a wireless signal that conforms to predetermined communication standards. More specifically, the control section 110 controls, for example, transmission and reception of an ultra wide band signal (that is expressed as a UWB signal below).

Note that the UWB signal has been described as an example of the predetermined communication standards. However, the predetermined communication standards are not limited to the UWB signal. For example, the predetermined communication standards according to the present embodiment include various communication standards that can measure a propagation time of a signal between wireless communication devices.

Functions of the control section 110 according to the present embodiment are configured by, for example, various processors.

The wireless communication section 120 is an example of a wireless communication section according to the present invention, and transmits and receives wireless signals that conform to the predetermined communication standards. For example, the wireless communication section 120 receives a trigger signal transmitted from the portable device 20. Furthermore, after receiving the trigger signal, the wireless communication section 120 transmits a request signal to the portable device 20 according to control of the control section 110. Furthermore, the wireless communication section 120 receives a response signal transmitted from the portable device 20 as a response to the request signal.

The processing section 130 is an example of a processing section according to the present invention, and may perform an operation based on a time at which a signal has been transmitted and received between the in-vehicle equipment 10 and the portable device 20. In this regard, the operation based on the time at which the signal has been transmitted and received includes, for example, an operation of estimating a positional relationship between devices.

More specifically, the operation of estimating the positional relationship between the devices includes, for example, a distance measurement operation of estimating a distance between devices based on a propagation time of the signal transmitted and received between the in-vehicle equipment 10 and the portable device 20. Furthermore, the operation of estimating the positional relationship between the devices may be, for example, an operation of estimating an arrival angle by using an Angle of Arrival (AoA) for a signal transmitted and received between the in-vehicle equipment 10 and the portable device 20.

On the other hand, the above-described operation based on the time at which the signal has been transmitted and received is likely to cause an operation error caused by a clock shift that has occurred between the device and another device.

In addition, before the operation based on the time at which the signal has been transmitted and received, the processing section 130 may execute a correction process of correcting the operation error caused by the clock shift between the devices. Consequently, the processing section 130 can more precisely estimate a distance measurement value.

Note that the processing section 130 may execute the correction process in, for example, a signal propagation time operation process, or may execute the correction process with respect to the operation result after calculating the distance measurement value.

Furthermore, to correct the above-described operation error, the processing section 130 may detect the clock shift between the in-vehicle equipment 10 and the portable device 20 based on the signal received from the portable device 20.

When the processing section 130 detects the clock shift between the in-vehicle equipment 10 and the portable device 20, for example, the wireless communication section 120 may include information of the clock shift in a signal, and transmits the signal to the portable device 20. In this case, a processing section 230 of the portable device 20 may execute the above-described correction process, and perform the distance measurement operation between the in-vehicle equipment 10 and the portable device 20.

(Portable Device 20)

The portable device 20 according to the present embodiment is an example of a wireless communication device according to the present embodiment. The portable device 20 according to the present embodiment may be, for example, an electronic key, a smartphone, and a wearable terminal. The portable device 20 according to the present embodiment is, for example, carried by the user, and transmits and receives a wireless signal that conforms to the predetermined communication standards to and from the in-vehicle equipment 10 mounted on a movable body such as a vehicle used by the user.

As illustrated in FIG. 1, the portable device 20 according to the present embodiment includes a control section 210, a wireless communication section 220, and the processing section 230.

The control section 210 controls an entire operation of the portable device 20. For example, the control section 210 controls transmission and reception of a wireless signal that conforms to the predetermined communication standards. For example, the control section 210 performs control to transmit a response signal as a response to a request signal to the wireless communication section 220.

The control section 210 according to the present embodiment includes, for example, various processors.

The wireless communication section 220 is an example of a wireless communication section according to the present invention, and transmits and receives a wireless signal that conforms to the predetermined communication standards. For example, the wireless communication section 220 transmits a trigger signal to the in-vehicle equipment 10. Furthermore, the wireless communication section 220 receives the request signal from the wireless communication section 120 of the in-vehicle equipment 10. Furthermore, the wireless communication section 220 transmits the response signal as the response to the request signal according to control of the control section 210.

Note that the wireless communication section 220 of the portable device 20 may transmit the request signal. In this case, the wireless communication section 220 receives the response signal transmitted from the wireless communication section 120 as the response to the request signal.

The processing section 230 is an example of a processing section according to the present invention, and may perform an operation based on a time at which a signal has been transmitted and received between the in-vehicle equipment 10 and the portable device 20. When the processing section 230 performs the operation, the processing section 230 may execute the correction process of correcting the operation error caused by the clock shift between the devices.

One of the processing section 130 of the in-vehicle equipment 10 and the processing section 230 of the portable device 20 executes the above-described operation and correction process. On the other hand, a processing section of a device different from a device that executes the operation and the correction process may detect the clock shift between the devices.

As described above, the processing section 130 of the in-vehicle equipment 10 and the processing section 230 of the portable device 20 may be combined and realize a function, or one of the processing sections may realize all functions. In a case where one of the processing sections realizes all functions, the other wireless communication device may not include the processing section.

For example, the processing section 130 of the in-vehicle equipment 10 detects the clock shift between the in-vehicle equipment 10 and the portable device 20 based on the received signal. Next, the wireless communication section 120 of the in-vehicle equipment 10 transmits the signal including the information of the clock shift to the portable device. Furthermore, the processing section 230 of the portable device 20 may perform the operation based on the time at which the signal has been transmitted and received between the in-vehicle equipment 10 and the portable device 20, and execute the correction process of correcting the operation error caused by the clock shift in the process of the operation.

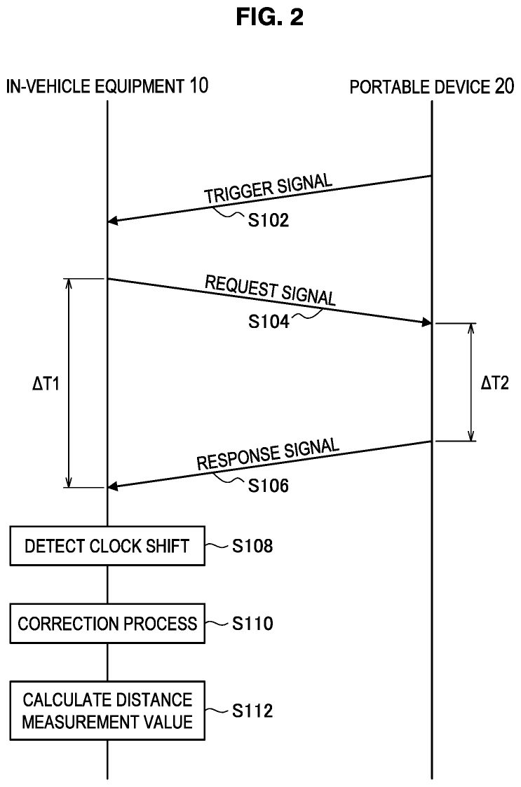

The configuration example of the system 1 according to the present embodiment has been described above. Next, details of the correction process according to the present embodiment will be described with reference to FIG. 2.

<<1.2. Details of Correction Process>>

FIG. 2 is a sequence diagram for explaining an example of the correction process of correcting the operation error caused by the clock shift between the in-vehicle equipment 10 and the portable device 20 according to the present embodiment.

The system 1 including the one in-vehicle equipment 10 and the one portable device 20 will be described as an example with reference to FIG. 2. However, the system 1 may include pluralities of pieces of the in-vehicle equipment 10 and the portable devices 20.

Furthermore, a method for estimating a distance measurement value based on a signal propagation time will be described as an example of an operation based on a time at which a signal has been transmitted and received between the in-vehicle equipment 10 and the portable device 20 with reference to FIG. 2. However, the present invention is not limited to this example.

First, as illustrated in FIG. 2, the wireless communication section 220 of the portable device 20 transmits a trigger signal that conforms to the predetermined communication standards according to control of the control section 210, and the wireless communication section 120 of the in-vehicle equipment 10 receives the trigger signal (S102).

Furthermore, the wireless communication section 120 of the in-vehicle equipment 10 that has received the trigger signal transmits a request signal that conforms to the predetermined communication standards according to control of the control section 110, and the wireless communication section 220 of the portable device 20 receives the request signal (S104).

Next, the wireless communication section 220 of the portable device 20 transmits a response signal according to control of the control section 210, and the wireless communication section 120 of the in-vehicle equipment 10 receives the response signal (S106).

In this case, the wireless communication section 220 may include, in the response signal, information of a time length ΔT2 that passes until the wireless communication section 220 transmits the response signal after receiving the request signal, and transmit the response signal, or may include, in a signal different from the response signal, the information of the time length ΔT2 that passes until the wireless communication section 220 transmits the response signal after receiving the request signal, and separately transmit the signals.

Furthermore, the control section 210 may perform control to stand by for a fixed period of time after the request signal is received, and transmit the response signal. Consequently, the wireless communication section 220 can transmit the response signal without including, in the response signal, the information of the time length ΔT2 that passes until the wireless communication section 220 transmits the response signal after receiving the request signal.

In this regard, the processing section 130 can estimate a distance between the in-vehicle equipment 10 and the portable device 20 based on a communication propagation time of the transmitted and received signal. The communication propagation time is calculated based on a time length ΔT1 that passes until the wireless communication section 120 of the in-vehicle equipment 10 receives the response signal after transmitting the request signal, and the time length ΔT2 that passes until the wireless communication section 220 of the portable device 20 transmits the response signal after receiving the request signal.

More specifically, by subtracting the time length ΔT2 from the time length ΔT1, it is possible to calculate a time length required for propagation of the request signal and the response signal (i.e., a time required for round-trip communication). Consequently, the processing section 130 can calculate the time length (ΔT1−ΔT2)/2 required for one-way communication by dividing the time length by 2.

By multiplying the time required for the one-way communication with a speed of a known signal, the processing section 130 can estimate the distance, i.e., a distance measurement value between the in-vehicle equipment 10 and the portable device 20.

On the other hand, at a time of calculation of the above-described distance measurement value, the operation error caused by the clock shift between the in-vehicle equipment 10 and the portable device 20 is likely to occur. By executing the process of correcting the operation error, the processing section 130 can more precisely estimate the distance measurement value.

First, the processing section 130 of the in-vehicle equipment 10 according to the present embodiment detects the clock shift between the in-vehicle equipment 10 and the portable device 20 based on the response signal received by the wireless communication section 120 (S108).

Next, the processing section 130 executes the process of correcting the operation error caused by the clock shift based on the clock shift detected in S108 (S110). In addition, the processing section 130 may execute the correction process with respect to the operation of the communication propagation time of the transmitted and received signal, or may execute the correction process with respect to the distance measurement value after calculating the distance measurement value described below.

Furthermore, the processing section 130 estimates the above-described distance measurement value between the in-vehicle equipment 10 and the portable device 20.

Hereinafter, an example of a method where the processing section 130 detects the clock shift between the in-vehicle equipment 10 and the portable device 20 in S108 will be described.

For example, the control section 210 of the portable device 20 may control transmission of the response signal as a pulse wave of an arbitrary cycle (e.g., 8 ns). In this case, the wireless communication section 220 of the portable device 20 transmits the response signal according to control including the pulse wave of the arbitrary cycle (e.g., 8 ns).

However, due to the clock shift between the in-vehicle equipment 10 and the portable device 20, the wireless communication section 120 of the in-vehicle equipment 10 receives the response signal at, for example, a cycle (e.g., 10 ns) different from the arbitrary cycle controlled by the control section 210.

Thus, due to the clock shift between the in-vehicle equipment 10 and the portable device 20, the cycle changes between the signal transmitted from the portable device 20 and the signal received by the in-vehicle equipment 10.

The processing section 130 of the in-vehicle equipment 10 can detect the clock shift between the in-vehicle equipment 10 and the portable device 20 based on the change of the above-described cycle at which the signal has been transmitted and received.

The example of the method for detecting the clock shift based on the change of the cycle at which the signal has been transmitted and received has been described above. However, the clock shift between the in-vehicle equipment 10 and the portable device 20 may be detected based on changes of other features of the signal.

In addition, the above-described example has described the example where the processing section 130 of the in-vehicle equipment 10 executes the process in S106 to S110. However, the processing section 230 of the portable device 20 may execute the process. For example, the processing section 230 of the portable device 20 detects the clock shift between the in-vehicle equipment 10 and the portable device 20 based on the received request signal, and transmits the response signal including the information of the clock shift to the in-vehicle equipment 10. Furthermore, the processing section 130 of the in-vehicle equipment 10 may execute the correction process by using the information of the clock shift included in the received response signal, and perform the distance measurement operation.

Furthermore, in the above embodiment, the wireless communication section 120 of the in-vehicle equipment 10 transmits the request signal, and the wireless communication section 220 of the portable device 20 transmits the response signal as the response to the request signal. However, the present invention is not limited to this example. For example, the wireless communication section 220 of the portable device 20 may transmit the request signal, and the wireless communication section 120 of the in-vehicle equipment 10 may transmit the response signal as the response to the request signal.

### 2. Supplementary Explanation

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

For example, a series of processes of each device described in this description may be realized by using one of software, hardware, and a combination of the software and the hardware. Programs that configure the software are stored in advance in, for example, storage media (non-transitory media) provided inside or outside each device. Furthermore, each program is read on an RAM when, for example, executed by a computer, and is executed by a processor such as a CPU. The above storage media are, for example, a magnetic disk, an optical disk, a magneto-optical disk, and a flash memory. Furthermore, the above computer programs may be distributed via, for example, a network without using the storage media.

Furthermore, the processes described using the sequence diagram in this description may not necessarily be executed in the illustrated order. For example, some process steps may be executed in parallel. Furthermore, additional process steps may be adopted, and part of the process steps may be omitted.

What is claimed is:

1. A wireless communication device comprising:
a wireless communication section configured to transmit and receive a signal that conforms to predetermined communication standards; and
a processing section configured to execute a correction process of correcting an operation error during an operation, the operation error being caused by a clock shift between the wireless communication device and another wireless communication device, and the operation being based on a time at which the signal has been transmitted and received between the wireless communication device and the another wireless communication device.

2. The wireless communication device according to claim 1,
wherein the processing section executes the correction process by performing an operation of estimating a positional relationship between the wireless communication device and the another wireless communication as the operation based on the time at which the signal has been transmitted and received.

3. The wireless communication device according to claim 2,
wherein the processing section executes the correction process by performing estimation of a distance between the wireless communication device and the another wireless communication as the operation of estimating the positional relationship.

4. The wireless communication device according to claim 3,
wherein, after the transmission and the reception of the signal used for the estimation of the distance is finished, the processing section executes the correction process.

5. The wireless communication device according to claim 1,
wherein the signal includes a request signal received by the another wireless communication device, and a response signal received as a response to the request signal by the wireless communication device.

6. The wireless communication device according to claim 1,
wherein the processing section detects the clock shift between the wireless communication device and the another wireless communication device based on the received signal.

7. The wireless communication device according to claim 1,
wherein the signal includes a wireless signal that conforms to ultra wide band wireless communication.

8. A non-transitory computer readable storage medium having a program stored therein, the program causing a computer to realize:
a wireless communication control function configured to transmit and receive a signal that conforms to predetermined communication standards; and
a processing function configured to execute a correction process of correcting an operation error during an operation, the operation error being caused by a clock shift between wireless communication devices, and the operation being based on a time at which the signal has been transmitted and received between the wireless communication devices that have transmitted and received the signal.

9. A system comprising:
a first wireless communication device; and
a second wireless communication device,
wherein the first wireless communication device includes
a wireless communication section configured to transmit and receive a signal that conforms to predetermined communication standards, and
a processing section configured to execute a correction process of correcting an operation error during an operation, the operation error being caused by a clock shift between the first wireless communication device and the second wireless communication device, and the operation being based on a time at which the signal has been transmitted and received between the first wireless communication device and the second wireless communication device.
